(19) United States
(12) Patent Application Publication
(10) Pub. No.: US 2012/0005629 A1
(43) Pub. Date: Jan. 5, 2012

(54) TIGHTLY COUPLED LISTS AND FORMS FOR CREATING/VIEWING/EDITING DATA

(75) Inventors: Michael N. Tofinetti, Kanata (CA); Katha Kulasingam, Kanata (CA)

(73) Assignee: ALCATEL-LUCENT CANADA INC., Kanata (CA)

(21) Appl. No.: 12/827,469

(22) Filed: Jun. 30, 2010

(51) Int. Cl. G06F 3/048

(52) U.S. Cl. 715/840

(57) ABSTRACT

A graphic user interface is provided for displaying list portlets and form portlets within a perspective, the portlets representing data including entities represented in a database. The portlets have various widgets. Portlets are associated with other portlets, such that selection of a widget or of a name in one portlet may open another portlet. In this way, nested portlets can be easily navigated and entities can be configured easily.

### FIELD OF THE INVENTION

This invention relates to graphical user interfaces, and more particularly to a method of displaying multiple pieces of information.

### BACKGROUND OF THE INVENTION

Management of customer information in telecommunication networks often requires the presentation of many pieces of information. For example, information related to billing rates and expected levels of service must be presented to an administrator so that the administrator can obtain current information or can edit information stored in a database. The information may be presented as lines of text, but a graphical user interface allows an administrator to select various items, to more easily view the current state of the selected items, and to more easily change the information related to the selected items.

The flexibility given to the administrator may come at a cost, however. As the administrator selects different views of the information, different aspects of the information presented to the administrator in different windows may become difficult to manage, especially when the administrator starts moving the windows around. For example, the administrator may wish to view information concerning a particular subscriber in a telecommunication network. A Listing window is used to find existing subscribers or to create new ones. Individual subscribers are created or edited in forms specific to the subscriber data. These forms contain many fields, such as category, user identifier, description, a list of subscription identifiers, custom data, and a list of called station identifiers. Each of these called station identifiers contains a large amount of information dealing with Quality of Service (QoS) parameters: defaults, aggregate maximum bit rates, guaranteed bit rates, maximum bit rates for QoS classes, associated AF applications, and custom data. Many of these are lists which open up configuration forms of their own. In addition, there is a separate search facility to find a subscriber by a specific subscription identifier. This is a search window which opens on top of the subscriber list.

U.S. patent application 12/707,865, entitled “Perspective View”, filed on Feb. 18, 2010, and incorporated herein by reference, provides a solution to presenting many pieces of data. Information is presented in portlets organized within areas such that different portlets can be selected easily. The areas form a perspective, such that different areas, and hence different portlets, can be viewed simultaneously.

However, the portlets are not associated in any way. When viewing or configuring data in a portlet, a user must keep track of related data and separately create portlets for that data if it is to be viewed or edited. The number of such portlets and the amount of such data can become overwhelming, making management of the data within a database cumbersome. A method of associating data would make it easier to manage the data, and in particular make it easier for an administrator to manage customer information in a telecommunication network.

### SUMMARY OF THE INVENTION

According to one aspect, a method is provided for displaying a graphical user interface. A perspective is displayed, along with at least one area within the perspective. Within one of the at least one area, a first portlet is displayed. Within the first portlet, a pick button and a field in association with the pick button are displayed. Upon selection of the pick button, a second portlet is created. In one embodiment, a list of at least one selectable entity is displayed within the second portlet. A set button is also displayed within the second portlet. Upon selection of the set button, the field is set to have a value associated with a selected entity in the list and the second portlet is closed.

In another embodiment, a list of at least one entity is displayed within the first portlet. Upon selection of one of the at least one entity, a third portlet is created which displays properties of the entity.

The methods of the invention may be stored as processing instructions on computer-readable storage media, the instructions being executable by a computer processor.

The invention allows portlets to be strongly associated with other portlets. Various means are provided within portlets for opening further portlets, in particular list portlets and form portlets. These means include pick buttons and lists of selectable entity names. In this way, information about entities on which the main entity relies can be easily seen or modified.

### BRIEF DESCRIPTION OF THE DRAWINGS

The features and advantages of the invention will become more apparent from the following detailed description of the preferred embodiment(s) with reference to the attached figures, wherein:

FIG. 1 is a diagram of an example perspective;

FIG. 2 is a diagram of an example area;

FIG. 3a is a diagram of a portion of an example portlet according to one embodiment of the invention;

FIG. 3b is a diagram of a portion of the example portlet of FIG. 3a upon completion of the field therein according to one embodiment of the invention;

FIG. 4 is a diagram of a portion of another example portlet according to one embodiment of the invention; and

FIG. 5 is a diagram of a portion of yet another example portlet according to one embodiment of the invention.

It is noted that in the attached figures, like features bear similar labels.

### DETAILED DESCRIPTION OF THE PREFERRED EMBODIMENTS

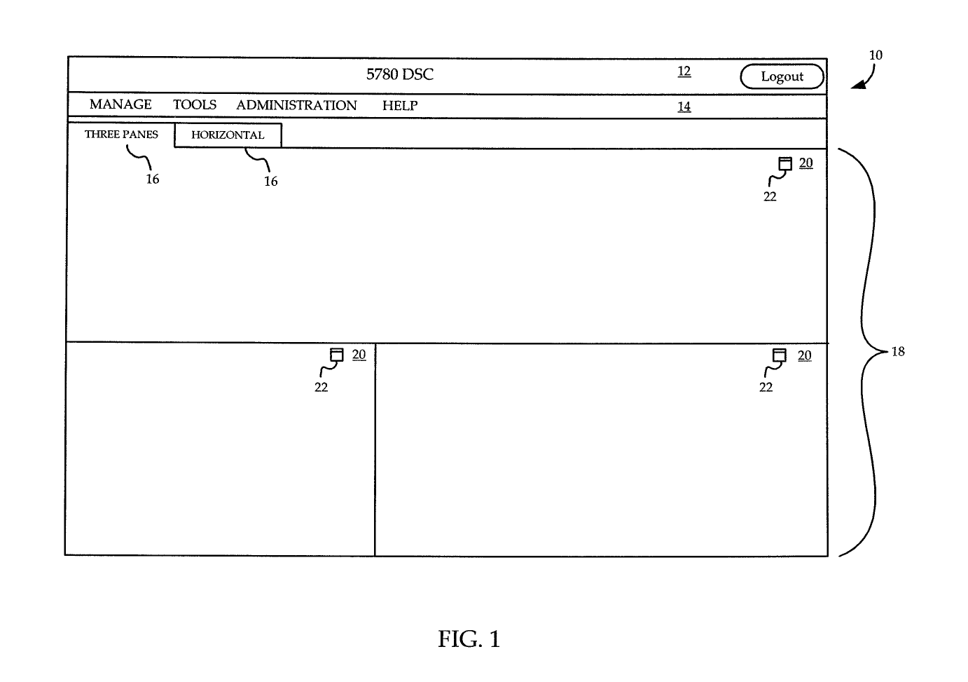

Referring to FIG. 1, a diagram of an example perspective according to one embodiment of the invention is shown. At the top level a user is presented with an application interface 10. Preferably, the application interface 10 occupies the entire display area of a display device. The application interface 10 includes a title bar 12, a menu bar 14, one or more tabs 16 called “perspective tabs”, and one or more stacked views called “perspectives” 18. Each perspective tab 16 has an associated perspective 18, and selecting one of the perspective tabs makes the perspective 18 associated with that perspective tab visible. Each perspective is an overall view of some aspect of information. Only one perspective is displayed, but if more than one perspective is available then the user can select a particular perspective to be displayed using the perspective tabs. In the example shown in FIG. 1, the user can select between two perspectives. The available perspectives may be either predefined or may be generated by the user. Generation of a perspective by a user provides flexibility in what data the user sees or interacts with.

Each perspective contains at least one pane, termed an “area”. In the example shown in FIG. 1, the perspective 18 contains three areas 20. Within a displayed perspective 18, the areas 20 may be resized but in general may not be created or destroyed. In other words, the number of areas within each perspective is normally fixed, but more generally a user may create one or more areas within a perspective. The definition of each area includes the types of portlet (described below) permitted in the area, in other words the types of portlet that can exist or be created within the area. Each area also has a maximize icon 22 for maximizing the area to occupy the entire perspective view, at which point a normalize icon (not shown in FIG. 1) becomes visible or selectable for restoring the area to its normal size.

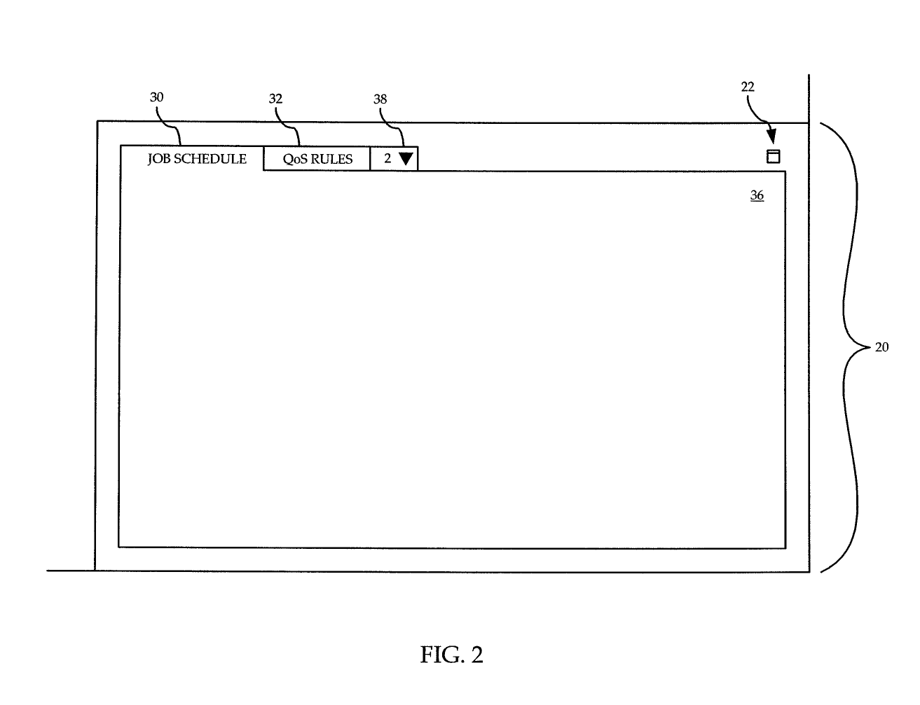

Referring to FIG. 2, a diagram of an example area 20 according to one embodiment of the invention is shown. The area may include at least one tab 30 and 32 called a “portlet tab”, and at least one stacked panel called a “portlet” 36. If a portlet tab is not visible due to width constraints of the area in which the portlet tab would otherwise be present, then a drop-down list 38 containing identifications of additional portlets is used. Each portlet tab and if present each item in the drop-down list has an associated portlet, and selecting one of the portlet tabs or an item in the drop-down list makes the portlet 36 associated with that portlet tab or item visible. Each portlet is a display of a particular piece of the information. Only one portlet is displayed within each area, but if more than one portlet is available then the user can select a particular portlet to be displayed using the portlet tabs or drop-down list within the area. In the example shown in FIG. 2, the user can select between four portlets in the area, although selection of a portlet for viewing in an area does not affect which portlets are selectable or visible in other areas.

Each portlet presents information specific to that portlet. A portlet can be a list of information or a form presenting current information and allowing the current information to be changed. Portlets can be destroyed in an area and can be added to an area. A portlet can also be moved between areas by clicking and dragging the portlet to a destination area, as long as the type of portlet is allowed in the destination area.

Broadly, a graphic user interface is provided displaying list portlets and form portlets having various widgets. Portlets are associated with other portlets, such that selection of a widget or of a name in one portlet may open another portlet.

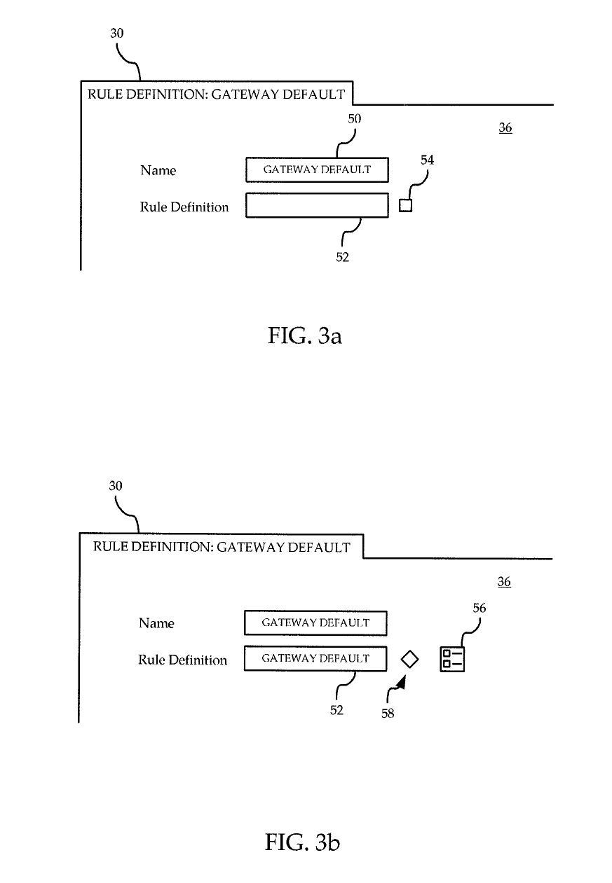

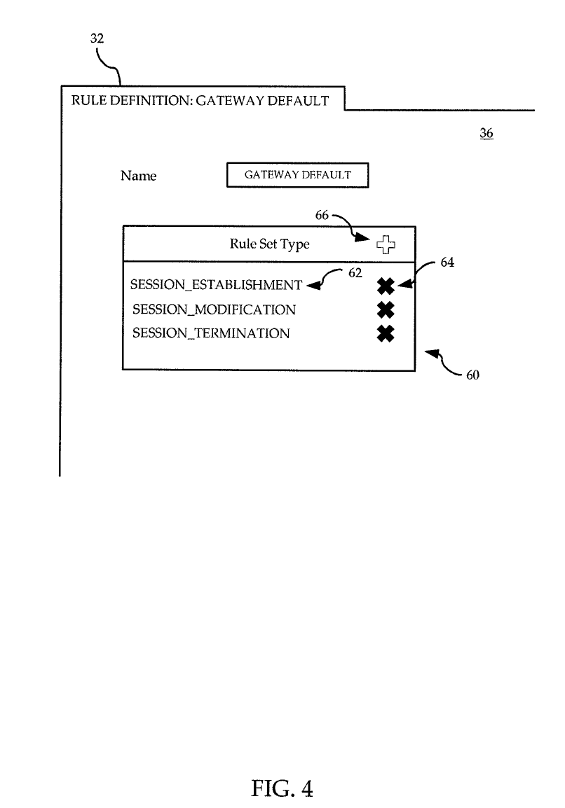

Referring to FIG. 3a, a portion of an example form portlet according to one embodiment of the invention is shown. The portlet 36 of FIG. 3a includes a name field 50 which contains the name of the portlet 36, and a rule definition field 52. The rule definition field 52 is for purposes of illustration only, and more generally any field 52 may be used. When the rule definition field 52 is blank, as shown in FIG. 3a, a pick button 54 is present. Selection of the pick button 54 opens a list portlet which contains a list of entities which may be selected for entry into the rule definition field 52, as described below with reference to FIG. 4. Use of a pick button 54 and an associated list portlet allows 1:1 associations to be established between two entities.

Referring to FIG. 3b, a portion of the form portlet of FIG. 3a according to one embodiment of the invention is shown. The portlet of FIG. 3b is the same portlet as in FIG. 3a, but the rule definition field 52 contains an entry indicating an entity. When the rule definition field 52 is not blank, i.e. the value of the rule definition field 52 is non-NULL, as shown in FIG. 3b, the pick button 54 is not present. Instead, a properties button 56 and a clear button 58 are present. If the user selects the properties button 56, a new portlet is opened which contains the properties of the entity indicated by the value of the rule definition field 52. If the user selects the clear button 58, the rule definition field 52 is cleared, i.e. the value of the rule definition field 52 is set to NULL, the properties button 56 and the clear button 58 disappear, and the pick button 54 re-appears.

Referring to FIG. 4, a portion of another form portlet according to one embodiment of the invention is shown. The portlet 36 includes a list 60 of at least one entity associated with the portlet. Each entry in the list 60 includes a name 62 and a remove button 64. The entire list 60 also includes an add button 66. Selection by the user of one of the names 62 opens a portlet showing information for the entity indicated by the name 62. Selection by the user of one of the remove buttons 64 removes the entity from the list 60. Selection by the user of the add button 66 opens another list portlet showing the entities eligible to be added to the list 60. Use of a list within a form portlet allows 1:n associations to be established between the entity represented by the form portlet and any number of other entities.

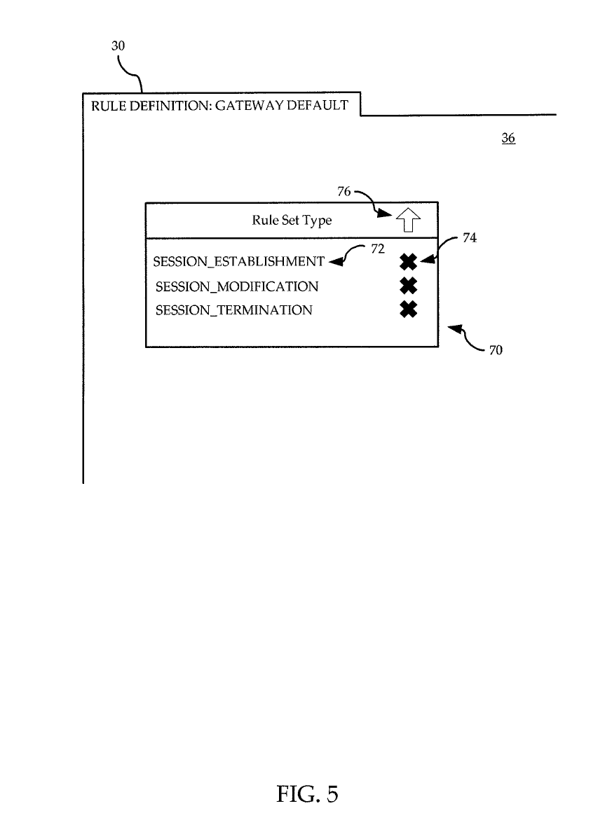

Referring to FIG. 5, a portion of a list portlet according to one embodiment of the invention is shown. The portlet 36 includes a list 70 of entities associated with the portlet. This type of list portlet is usually shown upon selection of a pick button 54 by a user, but may be used in other circumstances. The list portlet contains a list 70 of at least one entity associated with the portlet, each entry in the list 70 including a name 72 and a remove button 74. The entire list 70 also includes a set button 76. Selection by the user of one of the names 72 opens a portlet showing information for the entity indicated by the name 72. Selection by the user of one of the remove buttons 74 removes the entity from the list 70. If one of the entries in the list 70 has been highlighted by the user, then selection by the user of the set button 76 sets the highlighted entry as the entity associated with the action that created the list portlet. For example, if the list portlet was created in response to the selection of a pick button 54, then the entity indicated by the highlighted entry in the list 70 will be set as the entity given in the rule definition field 52.

In general, the portlets described above interact in a nested way, in that a portlet may open other portlets related to information contained in the first portlet. This may continue, and several portlets may be opened successively from each other. For example, an initial list portlet may be presented to a user listing entities in a telecommunication network customer database that can be configured by a user. Selection of an entry in the initial list portlet opens a form portlet for configuring that entity. This form portlet includes a 1:1 association and a 1:n association. When a user selects the pick button for the 1:1 association, another list portlet is opened from which the user can select an entity for inclusion in the field associated with the pick button. The user can also see the properties of any entity in this other list item by selecting one of the entities, or can see the properties of the entity in the field associated with the pick button once such an entity is set. Viewing the properties of the entity opens yet another form portlet, which may contain some values that can be configured by the user.

The user can also add an entity to the list in the form portlet representing the 1:n association, or remove an entity from such a list. Selecting the add button for the list opens a list portlet listing entities that can be added to the list in the form portlet.

The above is an example only, and more generally a first portlet may open a second portlet by interaction with a widget of the first portlet or selection of an entity name in the first portlet.

In order to implement the associations between list and form portlets, the definition file of each portlet includes a type definition associated with each widget which can open another portlet. Examples of such widgets are the pick button 54 and the add button 66. For example, when a user selects the pick button 54, the underlying system determines which entity types are specified for the pick button 54 based on the type definition defined in the definition file of the portlet containing the pick button, and opens a list portlet listing entities which match the entity type specified for the pick button 54. A developer of a new portlet need only specify an entity type for any such widget in the portlet, without having to be aware of how the underlying system behaves in response to selection of the widget.

The logic of the methods is preferably in the form of software, and may be stored as instructions on computer-readable storage media. The information presented in the portlets may be information about customers in a telecommunication network, which may be obtained from a database, or may be any other sort of information.

The embodiments presented are exemplary only and persons skilled in the art would appreciate that variations to the embodiments described above may be made without departing from the spirit of the invention. For example, the various menus, title bars, and icons described above and shown in the figures are examples only, and other text and/or icons can be used. The scope of the invention is solely defined by the appended claims.

I/we claim:

1. A method of displaying a graphical user interface, comprising:
displaying a perspective;
within the perspective, displaying at least one area;
within one of the at least one area, displaying a first portlet;
within the first portlet, displaying a pick button and a field in association with the pick button; and
upon selection of the pick button, creating a second portlet.

2. The method of claim 1 further comprising:
displaying within the second portlet a list of at least one selectable entity;
displaying a set button within the second portlet;
setting the field to have a value associated with a selected entity in the list upon selection of the set button; and
closing the second portlet upon selection of the set button.

3. The method of claim 2 further comprising:
if the field contains a non-NULL value, hiding the pick button and displaying a clear button and a properties button in the first portlet;
upon selection of the clear button, setting the value of the field to be NULL; and
upon selection of the properties button, creating a third portlet which displays properties of an entity indicated by the value of the field.

4. The method of claim 3 further comprising: displaying a second field in the third portlet, for which a value can be set by a user.

5. The method of claim 4 further comprising:
displaying within the third portlet a second pick button in association with the second field; and
upon selection of the send pick button, creating of fourth portlet containing a list of at least one additional selectable entity.

6. The method of claim 1 further comprising:
within the first portlet, displaying a list of at least one entity; and
upon selection of one of the at least one entity, creating a third portlet which displays properties of the entity.

7. The method of claim 6 further comprising:
displaying within the first portlet an add button in association with the list; and
upon selection of an add button, creating a fourth portlet which allows a new entity to be added to the list.

8. The method of claim 7 further comprising:
displaying within the fourth portlet a second field for which a value can be set by a user.
